(19) United States
(12) Patent Application Publication
(10) Pub. No.: US 2015/0285482 A1
(43) Pub. Date: Oct. 8, 2015

(54) SLEEVE-TYPE HEAT DISSIPATER FOR LAMP

(71) Applicants: Tzu Wang, Taoyuan County (TW); Pie-Jung Wang, Taoyuan County (TW)

(72) Inventor: Tzu WANG, Taoyuan County (TW)

(73) Assignees: Pie-Jung Wang, Taoyuan County (TW); Tzu Wang, Taoyuan County (TW)

(21) Appl. No.: 14/243,890

(22) Filed: Apr. 3, 2014

(51) Int. Cl. F21V 29/51; F28D 15/02

(52) U.S. Cl. CPC F21V 29/51; F28D 15/02

(57) ABSTRACT

A sleeve-type heat dissipater for a lamp includes: a heat conduction module which includes a heat conduction base, a first heat pipe, a second heat pipe and a press plate; a first heat dissipation member which includes a primary tubular body and a plurality of secondary tubular bodies annularly arranged at the outer periphery of the primary tubular body, two ends of the first heat pipe are respectively received in each of the secondary tubular bodies; and a second heat dissipation member which is detachably sleeved with the heat conduction module and the first heat dissipation member, and formed with a pair of accommodation slots respectively allowing two ends of the second heat pipe to be accommodated. Accordingly, the heat dissipater provided by the present invention can be coordinately adjusted with respect to the lamp with different power for providing an optimal heat dissipation effect.

### BACKGROUND OF THE INVENTION

1. Field of the Invention

The present invention relates to a heat dissipater, especially to a sleeve-type heat dissipater for a lamp.

2. Description of Related Art

Light emitting diodes (LEDs) have been being applied in a tool because of its advantages of high brightness, saving energy and long service life, a lamp module assembled by LEDs is able to generate great power so LEDs become one of the light sources having feature of environmental protection and saving energy.

However, the LEDs with higher power and brighter luminance would generate enormous amount of heat, if the accumulated heat cannot be effectively dissipated, the light emitting quality of the LED would be affected or even the LED itself would be damaged, so the service life of LED may be shortened, an effective heat dissipation design would ensure the light emitting quality of the LED and prolong the service life of LED. A conventional heat dissipater for a lamp is mostly design for being applied in a lamp with certain power, and an additional design is required if the heat dissipater is desired to be applied for a lamp with different power, thereby causing the disadvantages of larger expenditure for molds and higher storage cost. In addition, after the conventional heat dissipater is assembled, the heat dissipater is mostly not formed with a detachable structural design, so a recycling and reusing mechanism could not be provided.

### SUMMARY OF THE INVENTION

The present invention is to provide a sleeve-type heat dissipater for a lamp, in which a second heat dissipation member thereof is able to be coordinately adjusted with respect to the lamp with different power.

Accordingly, the present invention provides a sleeve-type heat dissipater for a lamp, which includes a heat conduction module, a first heat dissipation member and a second heat dissipation member; the heat conduction module includes a heat conduction base, a first heat pipe, a second heat pipe and a press plate, and the first heat pipe and the second pipe are staggeringly arranged and installed on the heat conduction base, the press plate is served to press the first heat pipe and the second heat pipe for being combined with the heat conduction base; the first heat dissipation member includes a primary tubular body and a plurality of secondary tubular bodies annularly arranged at the outer periphery of the primary tubular body, two ends of the first heat pipe are respectively received in each of the secondary tubular bodies; the second heat dissipation member is detachably sleeved with the heat conduction module and the first heat dissipation member, and the second heat dissipation member is formed with a pair of accommodation slots respectively allowing two ends of the second heat pipe to be accommodated.

Accordingly, the present invention provides a sleeve-type heat dissipater for a lamp, which includes a heat conduction module, a first heat dissipation member and a second heat dissipation member; the heat conduction module includes a heat conduction base, a first heat pipe, a second heat pipe and a press plate, and the first heat pipe and the second pipe are staggeringly arranged and installed on the heat conduction base, the press plate is served to press the first heat pipe and the second heat pipe for being combined with the heat conduction base; the first heat dissipation member includes a primary tubular body and a plurality of secondary tubular bodies annularly arranged at the outer periphery of the primary tubular body, two ends of the first heat pipe are respectively received in each of the secondary tubular bodies; the second heat dissipation member is sleeved with the heat conduction module and the first heat dissipation member, and the second heat dissipation member is formed with a pair of accommodation slots respectively allowing two ends of the second heat pipe to be accommodated.

In comparison with related art, the present invention has advantageous features as follows: with the design of the heat conduction module and the first heat dissipation member being able to be shared for being applied in the lamp with different power, the expenditure for molds and the storage cost can be greatly lowered; with air inlet holes formed on the round tubular body, external cold air is able to be introduced to the interior of the round tubular body for discharging the internal heat, thereby enhancing the heat dissipating effect; and with the semicircular accommodation slots formed in the second heat dissipation member, each condense segment is able to be easily assembled or detached.

### BRIEF DESCRIPTION OF DRAWING

FIG. 1 is a perspective exploded view showing the heat conduction module according to one embodiment of the present invention;

FIG. 2 is a schematic view showing the assembly of the heat conduction module according to one embodiment of the present invention;

FIG. 3 is a perspective exploded view showing the heat dissipater and the lens according to one embodiment of the present invention;

FIG. 4 is a schematic view showing the assembly of the heat dissipater and the lenses according to one embodiment of the present invention;

FIG. 5 is a cross sectional view illustrating the heat dissipater being applied in a lamp;

FIG. 6 is another cross sectional view illustrating the heat dissipater being applied in the lamp;

FIG. 7 is a top view showing the heat dissipater according to one embodiment of the present invention;

FIG. 8 is a schematic view illustrating the heat dissipater being applied in a projection lamp; and

FIG. 9 is a top view showing the assembly of the heat dissipater according to another embodiment of the present invention.

### DETAILED DESCRIPTION OF THE INVENTION

Preferred embodiments of the present invention will be described with reference to the drawings.

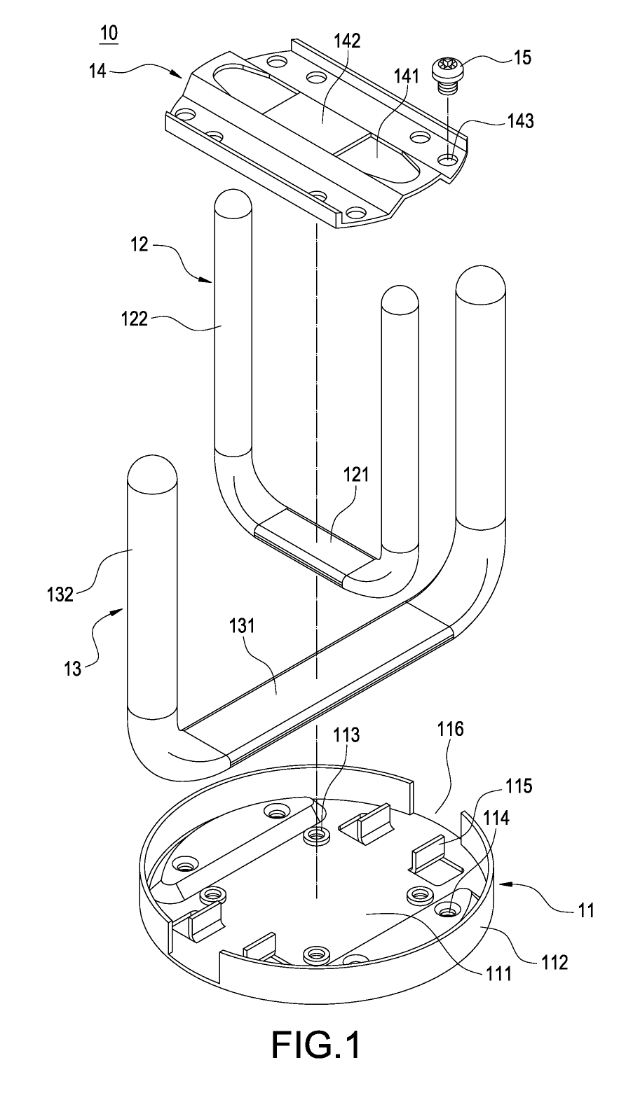

Please refer from FIG. 1 to FIG. 4, the present invention provides a sleeve-type heat dissipater for a lamp, which is mainly applied in a lamp with 20 W or higher power, especially applied in a lamp with 25˜40 W power for providing an optimal heat dissipating effect. The sleeve-type heat dissipater mainly includes a heat conduction module 10, a first heat dissipation module 20 and a second heat dissipation module 30.

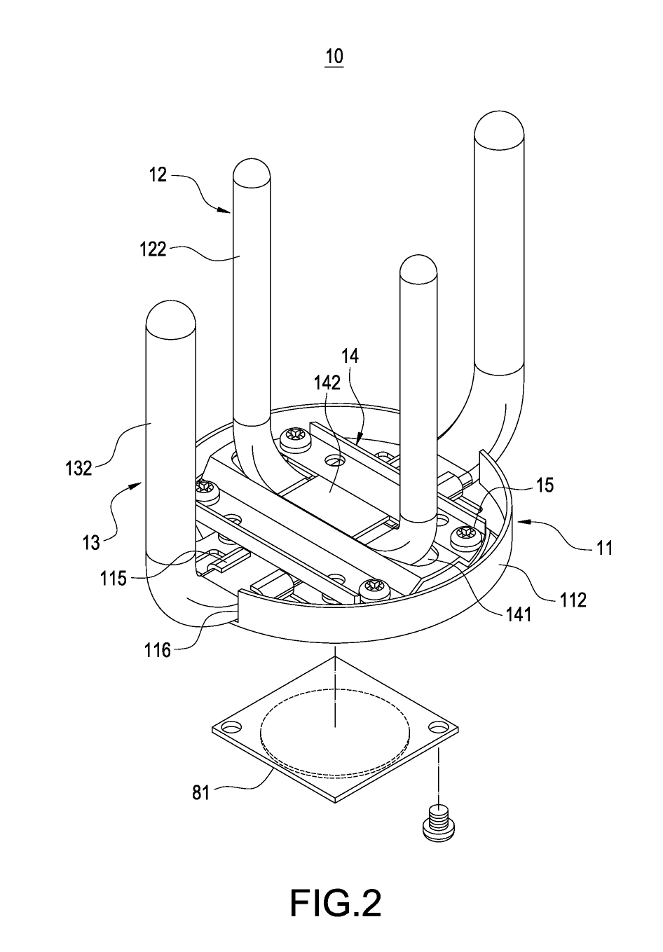

As shown in FIG. 1 and FIG. 2, the heat conduction module 10 includes a heat conduction base 11, a first heat pipe 12, a second heat pipe 13 and a press plate 14. The heat conduction base 11 is made of copper, aluminum or an alloy of copper and aluminum, substantially formed in round disk shape, and composed of a bottom plate 111 and a surround plate 112 upwardly extended from the periphery of the bottom plate 111, a plurality of screw studs 113 and a plurality of screw holes 114 are formed on the bottom plate 111; the outer side of the screw stud 113 is formed with two corresponding clip pieces 115, a notch 116 is respectively formed on the surround plate 112 corresponding to each of the clip pieces 115.

The first heat pipe 12 and the second heat pipe 13 are formed in a U-like shape, and the first heat pipe 12 is formed with a flat vaporization segment 121 and a round condense segment 122 respectively extended from two ends of the vaporization segment 121, the second heat pipe 13 is formed with a flat vaporization segment 131 and a round condense segment 132 respectively extended from two ends of the vaporization segment 131, the first heat pipe 12 and the second heat pipe 13 are installed on the heat conduction base 11, the vaporization segment 131 of the second heat pipe 13 is in thermal contact with the bottom plate 111, and each of the clip pieces 115 is bent for being abutted against the top surface of the vaporization segment 131, and each of the condense segments 132 of the second heat pipe 13 are protruded outside the surround plate 112 from each of the notches 116. The vaporization segment 121 of the first heat pipe 12 is stacked on the vaporization segment 131 of the second heat pipe 13, and the vaporization segment 121 and the vaporization segment 131 are staggeringly arranged thereby forming a cross-like status when viewing from the top.

The central area of the press plate 14 is formed with two penetrated slots 141 and a press segment 142 formed between the two penetrated slots 141, and the press plate 14 is formed with a plurality of penetrated holes 143 corresponding each of the screw studs 113 and each of the screw holes 114, the press segment 142 of the press plate 14 is served to press on the top surface of the vaporization segment 121 of the first heat pipe 12, and each of the condense segments 122 of the first heat pipe 12 is protruded out from the corresponding penetrated slot 141, and fasten members 15 such as screws are provided to pass the penetrated holes 143 for being fastened with the screw holes 114 and the screw studs 113 thereby enabling the first heat pipe 12 and the second heat pipe 13 to be pressed and fastened on the heat conduction base 11, accordingly the above-mentioned heat conduction module 10 is assembled, and the heat conduction module 10 can be served to provide a heat dissipating effect to a LED module 81 of a projection lamp 8.

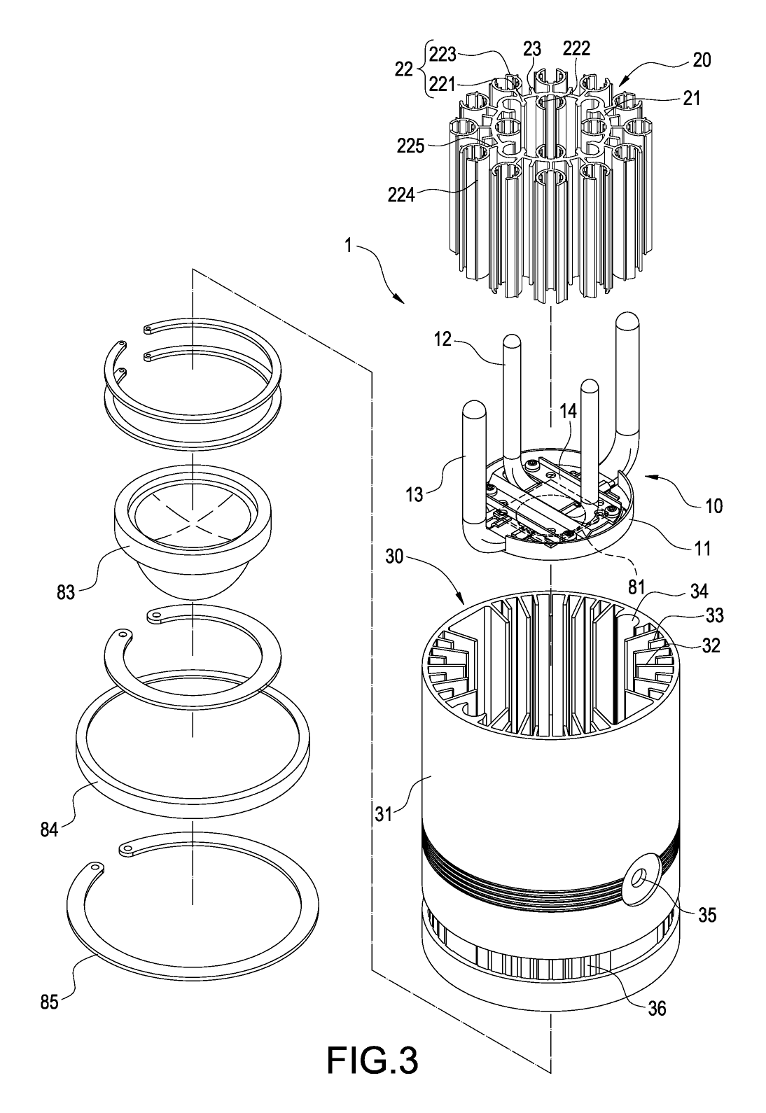

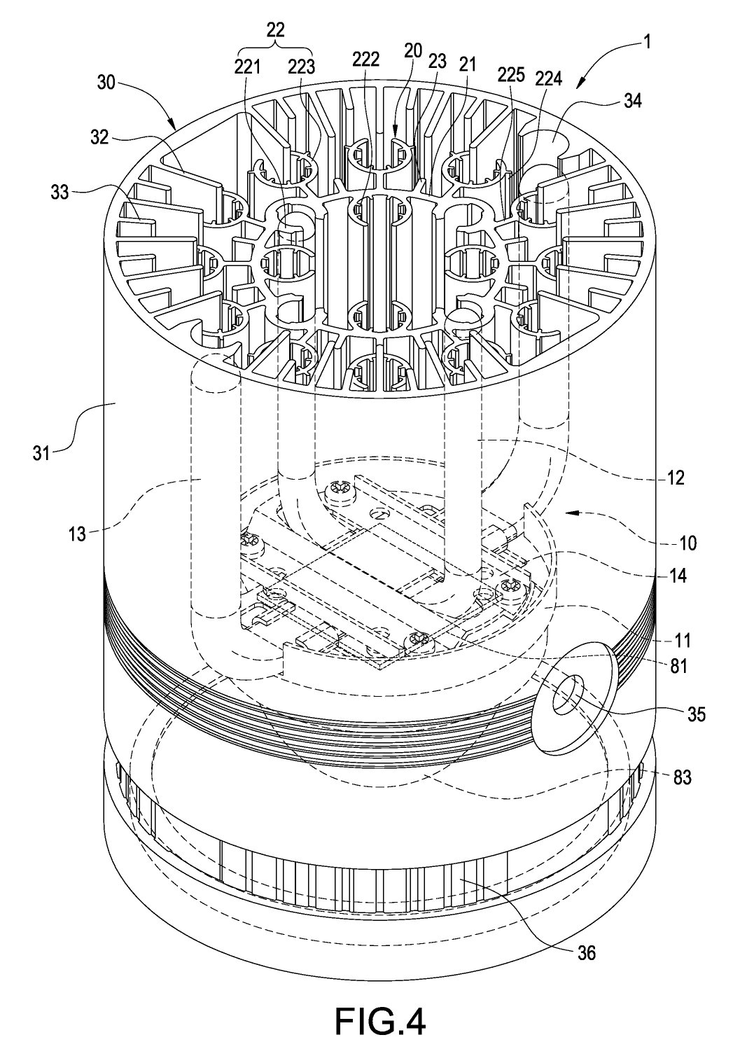

As shown in FIG. 3 and FIG. 4, the first heat dissipation member 20 is formed through aluminum or an alloy thereof being extruded, and includes a primary tubular body 21 and a plurality of secondary tubular bodies 22 annularly arranged at the outer periphery of the primary tubular body 21, the primary tubular body 21 is substantially formed in a round shape, and each of the secondary tubular bodies 22 is composed of a plurality of inner secondary tubular bodies 221 formed at the inner side of the primary tubular body 21 and a plurality of outer secondary tubular bodies 223 formed at the outer side of the primary tubular body 21, and a heat dissipation sheet 23 is formed between any two of the adjacent outer secondary tubular bodies 223 and outwardly extended from the primary tubular body 21, inner walls of a part of the inner secondary tubular bodies 221 are extended with a plurality of heat dissipation strips 222, inner and outer walls of a part of the outer secondary tubular bodies 223 are extended with a plurality of heat dissipation strips 224, and each of the outer secondary tubular bodies 223 is connected with the primary tubular body 21 through a connection arm 225. The two condense segments 122 of the first heat pipe 12 are respectively received in each of the inner secondary tubular bodies 221.

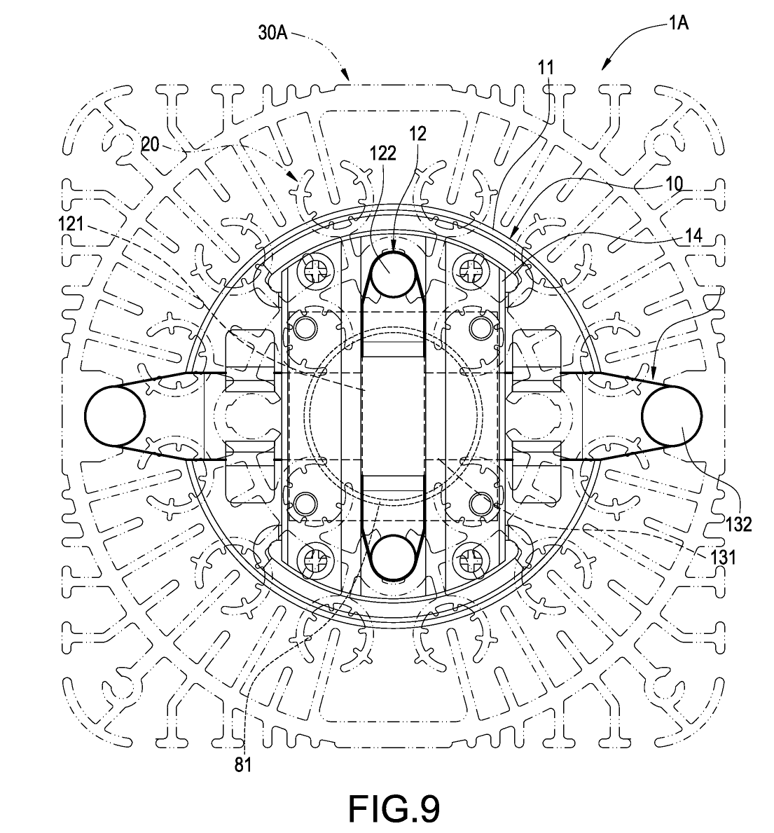

According to the sleeve-type heat dissipater 1 provided by the present invention, the heat conduction module 10 is fastened with the first heat dissipation member 20, so the fastened heat conduction module 10 and the first heat dissipation member 20 require a destructive means for being detached and separated. The second heat dissipation member 30 is detachably sleeved with the heat conduction module 10 and the first heat dissipation member 20, in other words the combination of the second heat dissipation member 30, the heat conduction module 10 and the first heat dissipation member 20 allows the second heat dissipation member 30 to be detached and separated from the heat conduction module 10 and the first heat dissipation member 20 by utilizing a simple tool, so another second heat dissipation member 30A (as shown in FIG. 9) can be used for replacement.

The second heat dissipation member 30 is formed through aluminum or an alloy thereof being extruded, and includes a round tubular body 31, a plurality of long heat dissipation fins 32 and a plurality of short heat dissipation fins 33 inwardly extended from the inner wall of the round tubular body 31, the short heat dissipation fin 33 is arranged between any two of the long heat dissipation fins 32, and a pair of accommodation slots 34 are formed at the central line of the round tubular body 31, the cross section of the accommodation slot 34 is formed in a semicircular shape thereby allowing the two condense segments 132 of the second heat pipe 13 to be accommodated therein, and the semicircular accommodation slot 34 is provided with a mechanism of enabling each of the condense segments 132 to be easily assembled or detached. The lower portion of the round tubular body 31 is correspondingly formed with a pivot hole 35, and a plurality of air inlet holes 36 are formed at the portion of the round tubular body 31 defined below the pivot hole 35.

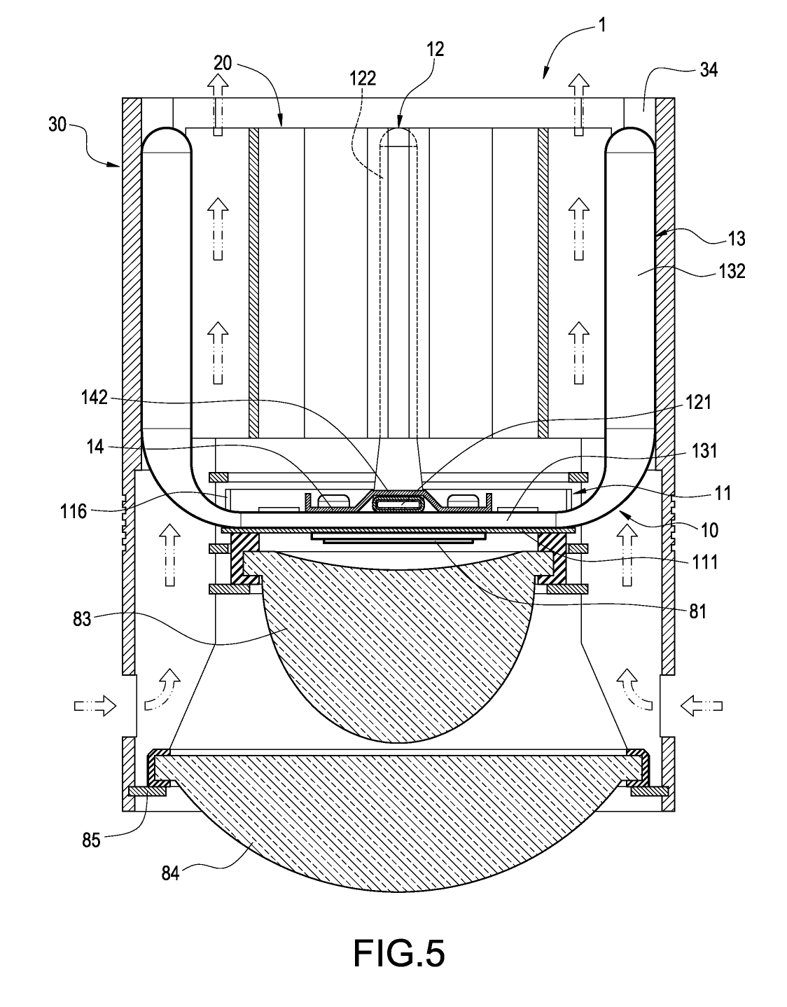

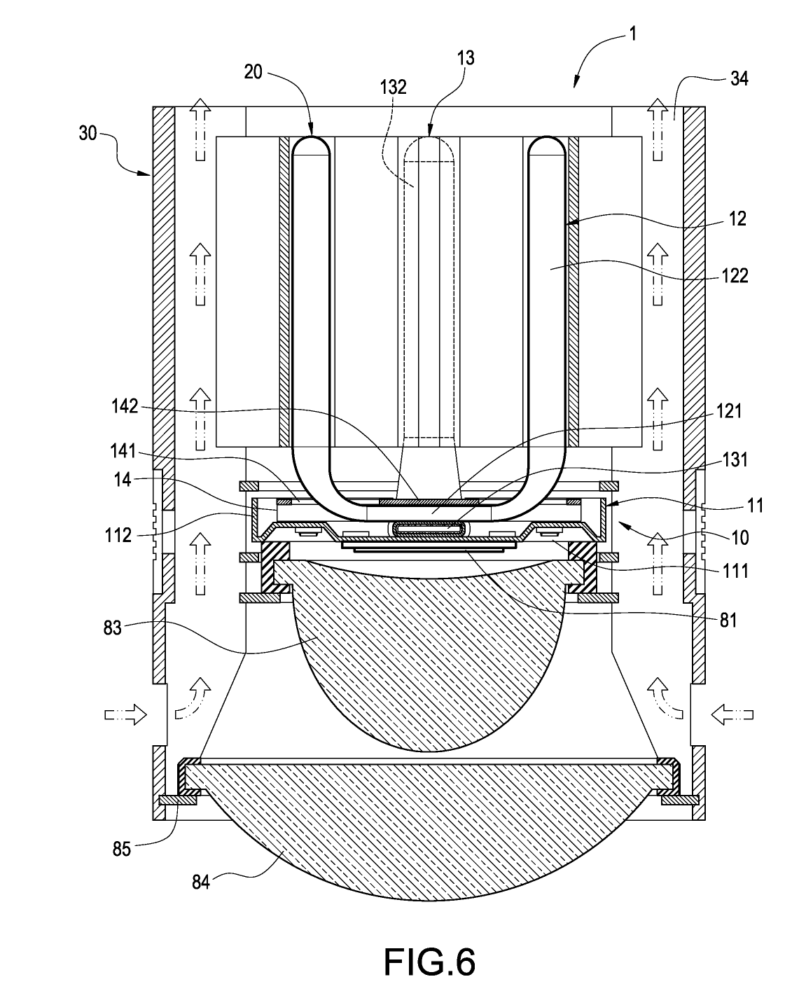

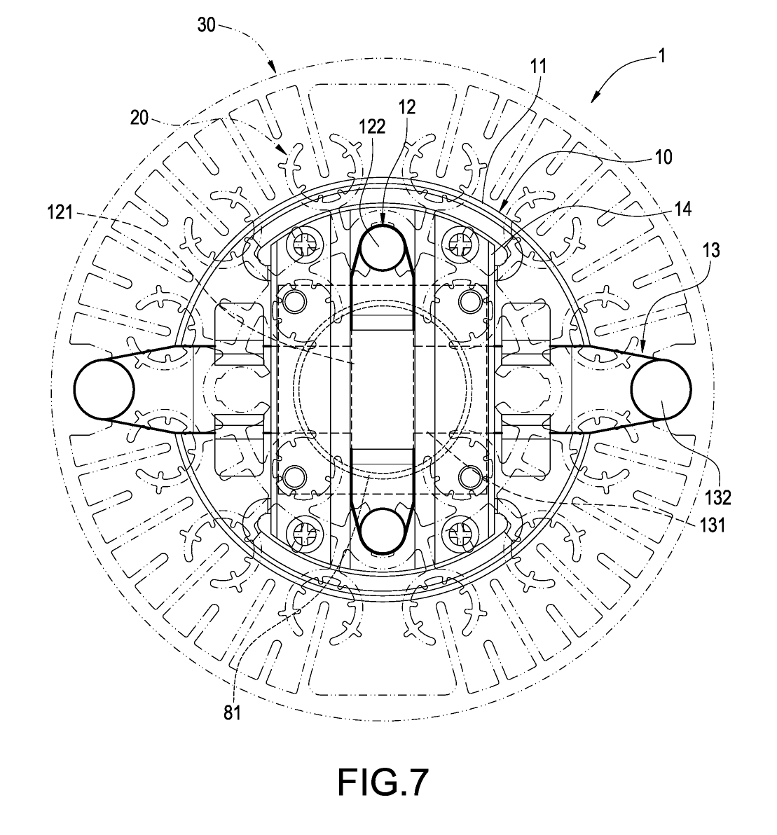

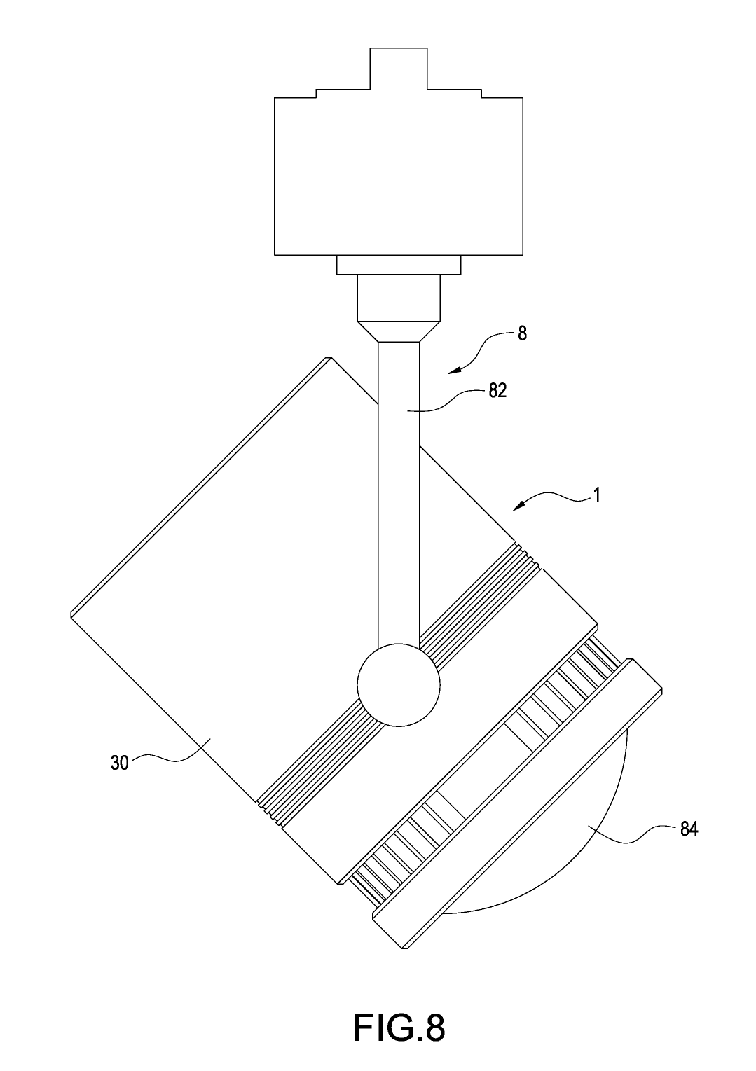

Please refer from FIG. 3 to FIG. 8, the sleeve-type heat dissipater 1 provided by the present invention can be applied in a projection lamp 8, the projection lamp 8 includes a LED module 81, a supporter 82, a first convex lens 83, a second convex lens 84 and a plurality of C-shaped buckles 85. The top surface of the LED module 81 is directly fastened and in thermal contact with the bottom plate 111 of the heat conduction base 11; the supporter 82 is pivoted with the pivot hole 35 through a pivotal shaft (not shown in figures); the first convex lens 83 and the second convex lens 84 are accommodated at the inner lower portion of the round tubular body 31 and fastened through the C-shaped buckles 85.

When in use, the heat generated by the LED module 81 is transferred by the heat conduction base 11 to the vaporization segment 131 of the second heat pipe 13, after the vaporization segment 131 is heated, a part of the heat is transferred to the vaporization segment 121 of the first heat pipe 12, and the other part of the heat is transferred through a heat transferring means utilizing gas-phase and liquid-phase being interconverted for enabling the heat to be transferred through each of the condense segments 132 to the round tubular body 31 of the second heat dissipation member 30, then the round tubular body 31 enables the heat to be dissipated to the exterior through the long heat dissipation fins 32 and the short heat dissipation fins 33, meanwhile after the vaporization segment 121 of the first heat pipe 12 is heated, the heat is transferred through the above-mentioned heat transferring means utilizing gas-phase and liquid-phase being interconverted for enabling the heat to be transferred through each of the condense segments 122 to the primary tubular body 21 of the first heat dissipation member 20, then the primary tubular body 21 enables the heat to be dissipated to the exterior through the inner secondary tubular bodies 221 and the outer secondary tubular bodies 223, and external cold air is introduced from the air inlet holes 36 through a heat convection effect, so the dissipated heat is enabled to be discharged from the upper portion of the first heat dissipation member 20 and the upper portion of the second heat dissipation member 30.

Please refer to FIG. 9, which is a top view showing the assembly of the heat dissipater according to another embodiment of the present invention. With the design of the second heat dissipation member 30 being able to be detachably sleeved with the heat conduction module 10 and the first heat dissipation member 20, a rectangular second heat dissipation member 30A can be used for replacing the above-mentioned round second heat dissipation member 30, the assembled sleeve-type heat dissipater 1A is able to be applied in a lamp with 40 W or higher power.

Based on what has been disclosed above, the sleeve-type heat dissipater for a lamp provided by the present invention can effectively improve the disadvantages existed in prior art.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A sleeve-type heat dissipater for a lamp, including:
a heat conduction module, including a heat conduction base, a first heat pipe, a second heat pipe and a press plate, wherein the first heat pipe and the second pipe are staggeringly arranged and installed on the heat conduction base, and the press plate is served to press the first heat pipe and the second heat pipe for being combined with the heat conduction base;
a first heat dissipation member, including a primary tubular body and a plurality of secondary tubular bodies annularly arranged at the outer periphery of the primary tubular body, wherein two ends of the first heat pipe are respectively received in each of the secondary tubular bodies; and
a second heat dissipation member, detachably sleeved with the heat conduction module and the first heat dissipation member, wherein the second heat dissipation member is formed with a pair of accommodation slots respectively allowing two ends of the second heat pipe to be accommodated.

2. The sleeve-type heat dissipater for a lamp according to claim 1, wherein the first heat pipe and the second heat pipe are both formed in a U-like shape, and the first heat pipe is formed with a first flat vaporization segment and two first round condense segments respectively extended from two ends of the first vaporization segment, the second heat pipe is formed with a second flat vaporization segment and two second round condense segments respectively extended from two ends of the second vaporization segment, and the first vaporization segment is stacked on the second vaporization segment.

3. The sleeve-type heat dissipater for a lamp according to claim 2, wherein the heat conduction base includes a bottom plate, the bottom plate is formed with a plurality of corresponding clip pieces, and each of the clip pieces is bent for being abutted against the second vaporization segment.

4. The sleeve-type heat dissipater for a lamp according to claim 3, wherein the heat conduction base further includes a surround plate upwardly extended from the periphery of the bottom plate, a notch is respectively formed on the surround plate corresponding to each of the clip pieces, and the second condense segment is protruded out from the notch.

5. The sleeve-type heat dissipater for a lamp according to claim 2, wherein the press plate is formed with two penetrated slots and a press segment formed between the two penetrated slots, the press segment is served to press the first vaporization segment, and the two penetrated slots respectively allow the two condense segments of the first heat pipe to be protruded.

6. The sleeve-type heat dissipater for a lamp according to claim 5, wherein the heat conduction base includes a bottom plate, a plurality of screw studs are formed on the bottom plate, the press plate is formed with a plurality of penetrated holes corresponding to each of the screw studs, a plurality of fasten members are provided to pass the penetrated holes for being fastened with the screw studs.

7. The sleeve-type heat dissipater for a lamp according to claim 5, wherein the heat conduction base includes a bottom plate, a plurality of screw holes are formed on the bottom plate, the press plate is formed with a plurality of penetrated holes corresponding to each of the screw holes, a plurality of fasten members are provided to pass the penetrated holes for being fastened with the screw holes.

8. The sleeve-type heat dissipater for a lamp according to claim 1, wherein each of the secondary tubular bodies is composed of a plurality of inner secondary tubular bodies formed at the inner side of the primary tubular body and a plurality of outer secondary tubular bodies formed at the outer side of the primary tubular body, and a heat dissipation sheet is formed between any two of the adjacent outer secondary tubular bodies and outwardly extended from the primary tubular body.

9. The sleeve-type heat dissipater for a lamp according to claim 8, wherein each of the outer secondary tubular bodies is connected with the primary tubular body through a connection arm, and inner and outer walls of each of the outer secondary tubular bodies are extended with a plurality of heat dissipation strips.

10. The sleeve-type heat dissipater for a lamp according to claim 8, wherein the second heat dissipation member includes a round tubular body, a plurality of long heat dissipation fins and a plurality of short heat dissipation fins inwardly extended from the inner wall of the round tubular body, the short heat dissipation fin is arranged between any two of the long heat dissipation fins, and the accommodation slot is formed in a semicircular shape and formed inside the round tubular body, and a plurality of air inlet holes are formed on the round tubular body.

11. A sleeve-type heat dissipater for a lamp, including:
a heat conduction module, including a heat conduction base, a first heat pipe, a second heat pipe and a press plate, wherein the first heat pipe and the second pipe are staggeringly arranged and installed on the heat conduction base, the press plate is served to press the first heat pipe and the second heat pipe for being combined with the heat conduction base;
a first heat dissipation member, including a primary tubular body and a plurality of secondary tubular bodies annularly arranged at the outer periphery of the primary tubular body, wherein two ends of the first heat pipe are respectively received in each of the secondary tubular bodies; and
a second heat dissipation member, sleeved with the heat conduction module and the first heat dissipation member, wherein the second heat dissipation member is formed with a pair of accommodation slots respectively allowing two ends of the second heat pipe to be accommodated.

12. The sleeve-type heat dissipater for a lamp according to claim 11, wherein the first heat pipe and the second heat pipe are both formed in a U-like shape, and the first heat pipe is formed with a first flat vaporization segment and two first round condense segments respectively extended from two ends of the first vaporization segment, the second heat pipe is formed with a second flat vaporization segment and two second round condenses segment respectively extended from two ends of the vaporization segment, and the first vaporization segment is stacked on the second vaporization segment.

13. The sleeve-type heat dissipater for a lamp according to claim 12, wherein the heat conduction base includes a bottom plate, the bottom plate is formed with a plurality of corresponding clip pieces, and each of the clip pieces is bent for being abutted against the second vaporization segment.

14. The sleeve-type heat dissipater for a lamp according to claim 13, wherein the heat conduction base further includes a surround plate upwardly extended from the periphery of the bottom plate, a notch is respectively formed on the surround plate corresponding to each of the clip pieces, and the second condense segment is protruded out from the notch.

15. The sleeve-type heat dissipater for a lamp according to claim 12, wherein the press plate is formed with two penetrated slots and a press segment formed between the two penetrated slots, the press segment is served to press the first vaporization segment, and the two penetrated slots respectively allow the two first condense segments to be protruded.

16. The sleeve-type heat dissipater for a lamp according to claim 15, wherein the heat conduction base includes a bottom plate, a plurality of screw studs are formed on the bottom plate, the press plate is formed with a plurality of penetrated holes corresponding to each of the screw studs, a plurality of fasten members are provided to pass the penetrated holes for being fastened with the screw studs.

17. The sleeve-type heat dissipater for a lamp according to claim 15, wherein the heat conduction base includes a bottom plate, a plurality of screw holes are formed on the bottom plate, the press plate is formed with a plurality of penetrated holes corresponding to each of the screw holes, a plurality of fasten members are provided to pass the penetrated holes for being fastened with the screw holes.

18. The sleeve-type heat dissipater for a lamp according to claim 11, wherein each of the secondary tubular bodies is composed of a plurality of inner secondary tubular bodies formed at the inner side of the primary tubular body and a plurality of outer secondary tubular bodies formed at the outer side of the primary tubular body, and a heat dissipation sheet is formed between any two of the adjacent outer secondary tubular bodies and outwardly extended from the primary tubular body.

19. The sleeve-type heat dissipater for a lamp according to claim 18, wherein each of the outer secondary tubular bodies is connected with the primary tubular body through a connection arm, and inner and outer walls of each of the outer secondary tubular bodies are extended with a plurality of heat dissipation strips.

20. The sleeve-type heat dissipater for a lamp according to claim 18, wherein the second heat dissipation member includes a round tubular body, a plurality of long heat dissipation fins and a plurality of short heat dissipation fins inwardly extended from the inner wall of the round tubular body, the short heat dissipation fin is arranged between any two of the long heat dissipation fins, and the accommodation slot is formed in a semicircular shape and formed inside the round tubular body, and a plurality of air inlet holes are formed on the round tubular body.
